(19) United States
(12) Patent Application Publication
(10) Pub. No.: US 2014/0258993 A1
(43) Pub. Date: Sep. 11, 2014

(54) SYSTEMS AND METHODS FOR DEVICE-SPECIFIC APPLICATION GENERATION

(71) Applicant: DELL PRODUCTS L.P., Round Rock, TX (US)

(72) Inventors: Charla Kunkel, Austin, TX (US); Jay McLain, Round Rock, TX (US); Vidya Kuram, Bangalore (IN)

(73) Assignee: DELL PRODUCTS L.P., Round Rock, TX (US)

(21) Appl. No.: 13/788,553

(22) Filed: Mar. 7, 2013

(51) Int. Cl. G06F 9/44

(52) U.S. Cl. CPC G06F 8/34
USPC 717/138

(57) ABSTRACT

In accordance with embodiments of the present disclosure, an information handling system comprising may include a processor, a memory communicatively coupled to the processor and having stored thereon a program of instructions. The instructions may be configured to, when read and executed by the processor: (i) receive user interface elements of content for displaying a web site; (ii) receive parameters associated with a client device; and (iii) based on the parameters, generate an application comprising one or more instructions, the one or more instructions of the application for emulating the user interface elements on the client device.

### TECHNICAL FIELD

The present disclosure relates in general to information handling systems, and more particularly to generation of device-specific applications for multiple information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many portable information handling systems, such as tablet computers and smart phones, may run an operating system for which applications are specifically written for use on such information handling system and such operating system. Due to the proliferation of different types of information handling systems available to consumers, developing an application for use on different information handling systems presents difficulty to design user interface elements and application flows specific to the respective information handling systems. Factors such as resolution, screen size, and device type are all different factors that may influence a type of user interface to display.

### SUMMARY

In accordance with the teachings of the present disclosure, the disadvantages and problems associated with generation of device-specific applications have been reduced or eliminated.

In accordance with embodiments of the present disclosure, an information handling system comprising may include a processor, a memory communicatively coupled to the processor and having stored thereon a program of instructions. The instructions may be configured to, when read and executed by the processor: (i) receive user interface elements of content for displaying a web site; (ii) receive parameters associated with a client device; and (iii) based on the parameters, generate an application comprising one or more instructions, the one or more instructions of the application for emulating the user interface elements on the client device.

In accordance with these and other embodiments of the present disclosure, a method comprising may include receiving user interface elements of content for displaying a web site. The method may also include receiving parameters associated with a client device. The method may further include, based on the parameters, generating an application comprising one or more instructions, the one or more instructions of the application for emulating the user interface elements on the client device.

In accordance with these and other embodiments of the present disclosure, an article of manufacture may include a computer readable medium; and computer-executable instructions carried on the computer readable medium, the instructions readable by a processor. The instructions, when read and executed, may causing the processor to: (i) receive user interface elements of content for displaying a web site; (ii) receive parameters associated with a client device; and (iii) based on the parameters, generate an application comprising one or more instructions, the one or more instructions of the application for emulating the user interface elements on the client device.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for generating client device-specific applications, in accordance with certain embodiments of the present disclosure;

FIG. 2 illustrates a flow chart of an example method for generating client device-specific applications, in accordance with certain embodiments of the present disclosure; and

FIG. 3 illustrates a flow chart of an example method of execution for a client device-specific application, in accordance with certain embodiments of the present disclosure.

### DETAILED DESCRIPTION

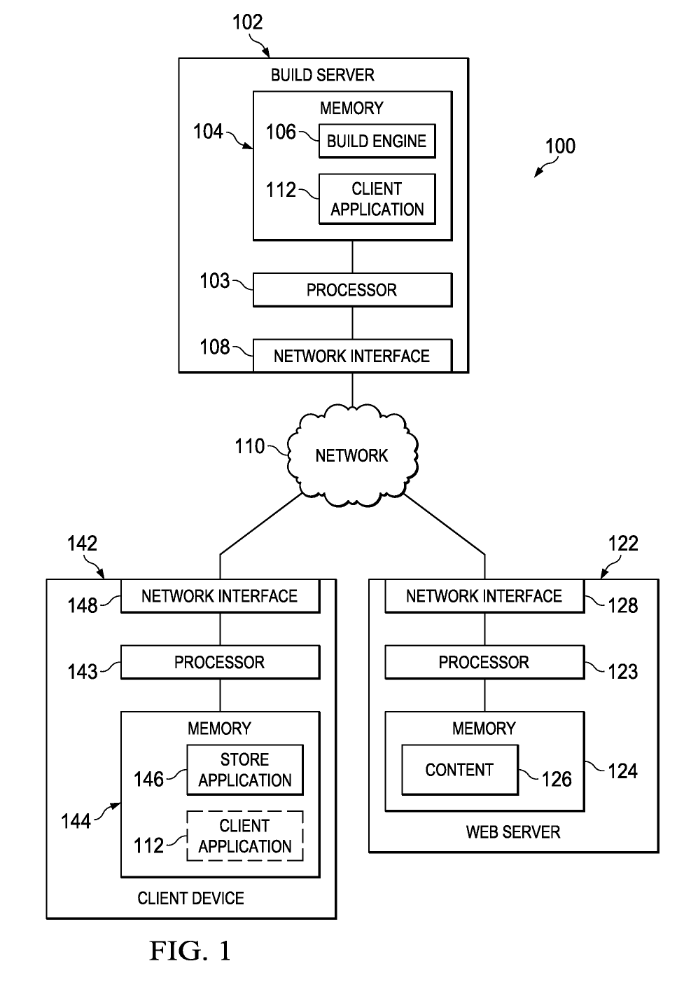

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, and one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

FIG. 1 illustrates a block diagram of an example system for generating client device-specific applications, in accordance with certain embodiments of the present disclosure. As shown in FIG. 1, system 100 may include a build server 102, a web server 122, a client device 142, and a network 110 communicatively coupling build server 102, web server 122, and client device 142 to one another.

Build server 102 may generally comprise an information handling system. In some embodiments, build server 102 may be a server. In other embodiments, build server 102 may be a personal computer (e.g., a desktop computer or a portable computer). As depicted in FIG. 1, build server 102 may include a processor 103, a memory 104 communicatively coupled to processor 103, and a network interface 108 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of build server 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to build server 102 is turned off.

As shown in FIG. 1, memory 104 may have stored thereon build engine 106. As described in greater detail elsewhere in this disclosure, build engine 106 may include any system, device, or apparatus configured to, based on user-interface elements present in content 126 and parameters associated with a particular type of client device 142, generate a client application 112 specific to the particular type of client device 142 and store such client application 112 on build server 102 or another suitable information handling system. In some embodiments, operating system build engine 106 may be implemented as a program of instructions that may be read by and executed on processor 103 to carry out the functionality of build engine 106.

As shown in FIG. 1, memory 104 may also have stored thereon a client application 112. As described in greater detail elsewhere in this disclosure, client application 112 may include an application executable on a particular type of client device 142 and generated based on user-interface elements present in content 126 and parameters associated with the particular type of client device 142. Client application 112 may be downloadable to client device 142 from build server 102, so that client application 112 may be downloaded and installed to and executed upon client device 142. In some embodiments, rather than storing a client application 112 to build server 102, build engine 106 may be configured to store client application 112 to another information handling system (not specifically shown in FIG. 1) to which client device 142 may communicatively couple in order to download and install client application 112. In some embodiments, client application 112 may be implemented as a program of instructions that may be read by and executed on processor 143 to carry out the functionality of client application 112.

Network interface 108 may comprise any suitable system, apparatus, or device operable to serve as an interface between build server 102 and network 110. Network interface 108 may enable build server 102 to communicate using any suitable transmission protocol and/or standard, including without limitation, all transmission protocols and/or standards enumerated below with respect to the discussion of network 110. In these and other embodiments, network interface 108 may comprise a network interface card, or “NIC.”

In addition to processor 103, memory 104, and network interface 108, build server 102 may include one or more other information handling resources.

Network 110 may be a network and/or fabric configured to couple build server 102, web server 122, and client device 142 to each other and/or one or more other information handling systems. In these and other embodiments, network 110 may include a communication infrastructure, which provides physical connections, and a management layer, which organizes the physical connections and information handling systems communicatively coupled to network 110. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

Web server 122 may generally comprise an information handling system. In some embodiments, web server 122 may be a server. In other embodiments, web server 122 may be a personal computer (e.g., a desktop computer or a portable computer). As depicted in FIG. 1, web server 122 may include a processor 123, a memory 124 communicatively coupled to processor 123, and a network interface 128 communicatively coupled to processor 123.

Processor 123 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 123 may interpret and/or execute program instructions and/or process data stored in memory 124 and/or another component of web server 122.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to web server 122 is turned off.

As shown in FIG. 1, memory 124 may have stored thereon content 126. In general, content 126 may include instructions or data for rendering a web site to a user. Such content may be embodied in files compliant with Hypertext Transfer Protocol (HTTP), Cascading Style Sheets (CSS), Javascript, and/or any other suitable format. Content 126 may include user-interface elements and data elements. User interface elements are portions of content 126 that define how data associated with the web site is displayed, including navigational information for crawling the web site, and other information defining the overall “look and feel” of the web site. Data elements comprise items of data that may display in a user interface defined by the user interface elements. In many applications, user interface elements may remain generally fixed or static while data elements may be variable or dynamic. For example, for a banking web site, the overall format for displaying an account holder's balance information may generally be static, while data elements representative of the actual account balance may vary as funds are transferred in and out of the account holder's account.

Network interface 128 may comprise any suitable system, apparatus, or device operable to serve as an interface between web server 122 and network 110. Network interface 128 may enable web server 122 to communicate using any suitable transmission protocol and/or standard, including any of the protocols and/or standards described above with respect to network 110. In these and other embodiments, network interface 128 may comprise a NIC.

In addition to processor 123, memory 124, and network interface 128, web server 122 may include one or more other information handling resources.

Client device 142 may generally comprise an information handling system. In some embodiments, client device 142 may be a mobile device sized and shaped to be readily transported and carried on a person of a user of client device 142 (e.g., a smart phone, a tablet computing device, a handheld computing device, a personal digital assistant, a notebook computer, etc.). As depicted in FIG. 1, client device 142 may include a processor 143, a memory 144 communicatively coupled to processor 143, and a network interface 148 coupled to processor 143.

Processor 143 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 143 may interpret and/or execute program instructions and/or process data stored in memory 144 and/or another component of client device 142.

Memory 144 may be communicatively coupled to processor 143 and may include any system, device, or apparatus configured to retain program instructions and/or data for a period of time (e.g., computer-readable media). Memory 144 may include RAM, EEPROM, a PCMCIA card, flash memory, magnetic storage, opto-magnetic storage, or any suitable selection and/or array of volatile or non-volatile memory that retains data after power to client device 142 is turned off.

As shown in FIG. 1, memory 144 may have stored thereon store application 146. As described in greater detail elsewhere in this disclosure, store application 146 may include any system, device, or apparatus configured to facilitate download (e.g., via network 110) of an application (e.g., client application 112) to client device 142 such that client device 142 may install and execute such application. In some embodiments, store application 146 may be in the form of an electronic commerce application whereby a user of client device 142 may select applications to download to client device 142, whether such applications may be downloaded for free or in exchange for a license fee.

Network interface 144 may comprise any suitable system, apparatus, or device operable to serve as an interface between client device 142 and network 110. Network interface 148 may enable client device 142 to communicate using any suitable transmission protocol and/or standard, including any of the protocols and/or standards described above with respect to network 110. In these and other embodiments, network interface 148 may comprise a NIC.

In addition to processor 143, memory 144, and network interface 148, client device 142 may include one or more other information handling resources.

In operation, build engine 106 may download or otherwise receive user interface elements from content 126, as well as parameters associated with a client device 142 or a type of client device 142 (e.g., display resolution, display size, device type, operating system, etc.) wherein such parameters may define how applications and data may be displayed (e.g., rendered, formatted, and/or navigated) on the particular type of client device 142. Based on such parameters, build engine 106 may generate executable instructions for emulating such user interface elements on the particular type of client device and compile such instructions as a client application 112.

At some time after build engine 106 completes its build of a client application 112, a client device 142 for which the client application 112 is compatible may download (e.g., from build server 102 or another information handling system communicatively coupled to client device 142) and install the client application 112. During execution, client application 112 may request data elements of content 126 from web server 122, and display such data elements within the user interface defined by client application 112.

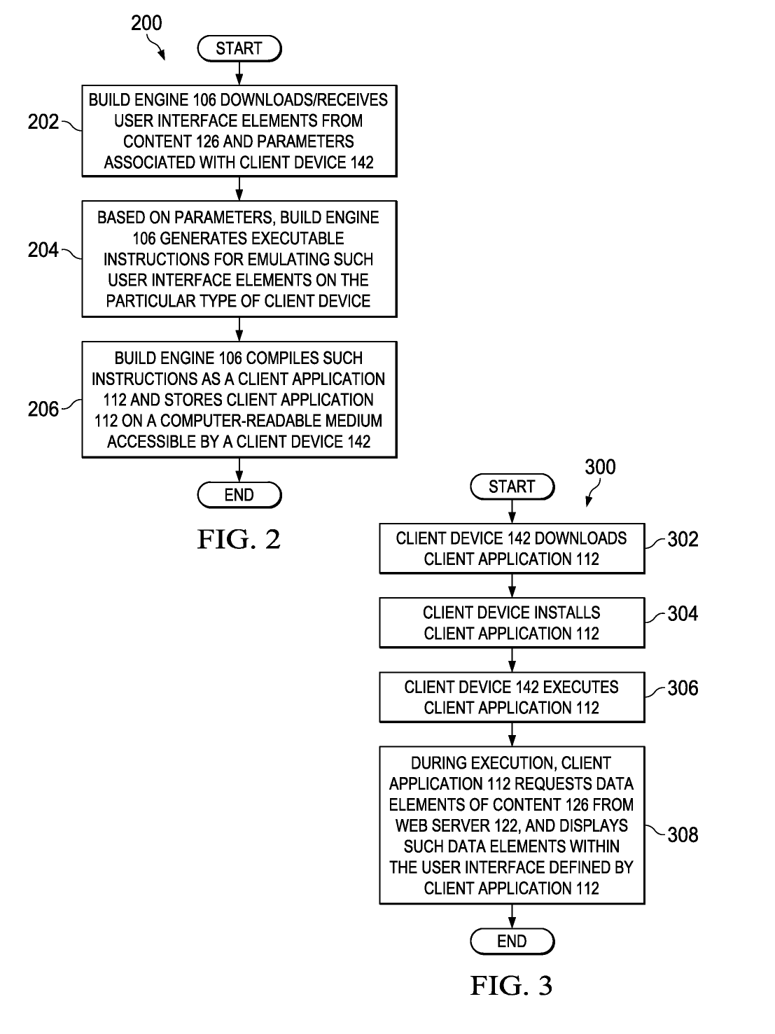

FIG. 2 illustrates a flow chart of an example method 200 for generating client device-specific applications, in accordance with certain embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, build engine 106 may download or otherwise receive user interface elements from content 126 and parameters associated with a client device 142 or a type of client device 142 (e.g., display resolution, display size, device type, operating system, etc.) wherein such parameters may define how applications and data may be displayed (e.g., rendered, formatted, and/or navigated) on the particular type of client device 142.

At step 204, based on such parameters, build engine 106 may generate executable instructions for emulating such user interface elements on the particular type of client device.

At step 206, build engine 106 may compile such instructions as a client application 112 and store client application 112 on a computer-readable medium accessible by a client device 142. After completion of step 206, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

FIG. 3 illustrates a flow chart of an example method 300 of execution for a client device-specific application, in accordance with certain embodiments of the present disclosure. According to some embodiments, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, a client device 142 may download (e.g., from build server 102 or another information handling system communicatively coupled to client device 142) client application 112. At step 304, client device 142 may install client application 112.

At step 306, client device 142 may execute client application 112. At step 308, during execution, client application 112 may request data elements of content 126 from web server 122, and display such data elements within the user interface defined by client application 112. After completion of step 308, method 300 may end.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using system 100 or any other system operable to implement method 300. In certain embodiments, method 300 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
a memory communicatively coupled to the processor and having stored thereon a program of instructions, the instructions configured to, when read and executed by the processor:
receive user interface elements of content for displaying a web site;
receive parameters associated with a client device; and
based on the parameters, generate an application comprising one or more instructions, the one or more instructions of the application for emulating the user interface elements on the client device.

2. The information handling system of claim 1, the client device comprising a mobile device sized and shaped to be readily transported and carried on a person of a user of the client device.

3. The information handling system of claim 1, the user interface elements comprising one or more of navigational information for crawling the web site and other information defining the overall look and feel of the web site.

4. The information handling system of claim 1, the parameters comprising one or more of a display resolution, a display size, a device type, and an operating system associated with the client device.

5. The information handling system of claim 1, the client application configured to be installed and executed on the client device.

6. The information handling system of claim 5, the client application further configured to, when executed:
request data elements of the content; and
display the data elements in a user interface defined by the client application.

7. A method comprising:
receiving user interface elements of content for displaying a web site;
receiving parameters associated with a client device; and
based on the parameters, generating an application comprising one or more instructions, the one or more instructions of the application for emulating the user interface elements on the client device.

8. The method of claim 7, the client device comprising a mobile device sized and shaped to be readily transported and carried on a person of a user of the client device.

9. The method of claim 7, the user interface elements comprising one or more of navigational information for crawling the web site and other information defining the overall look and feel of the web site.

10. The method of claim 7, the parameters comprising one or more of a display resolution, a display size, a device type, and an operating system associated with the client device.

11. The information handling system of claim 7, the client application configured to be installed and executed on the client device.

12. The information handling system of claim 11, the client application further configured to, when executed:
request data elements of the content; and
display the data elements in a user interface defined by the client application.

13. An article of manufacture comprising:
a computer readable medium; and
computer-executable instructions carried on the computer readable medium, the instructions readable by a processor, the instructions, when read and executed, for causing the processor to:
receive user interface elements of content for displaying a web site;
receive parameters associated with a client device; and
based on the parameters, generate an application comprising one or more instructions, the one or more instructions of the application for emulating the user interface elements on the client device.

14. The article of claim 13, the client device comprising a mobile device sized and shaped to be readily transported and carried on a person of a user of the client device.

15. The article of claim 13, the user interface elements comprising one or more of navigational information for crawling the web site and other information defining the overall look and feel of the web site.

16. The article of claim 13, the parameters comprising one or more of a display resolution, a display size, a device type, and an operating system associated with the client device.

17. The article of claim 13, the client application configured to be installed and executed on the client device.

18. The article of claim 17, the client application further configured to, when executed:
request data elements of the content; and
display the data elements in a user interface defined by the client application.
